(19) United States
(12) Patent Application Publication
(10) Pub. No.: US 2006/0143606 A1
(43) Pub. Date: Jun. 29, 2006

(54) Management of persistent software applications

(75) Inventors: Ronald R. Smith, Coral Springs, FL (US); Charles D. Estes, Ft. Lauderdale, FL (US); Jyh-Han Lin, Parkland, FL (US); Biren R. Patel, Coral Springs, FL (US)

Correspondence Address: FLEIT, KAIN, GIBBONS, GUTMAN, BONGINI;& BIANCO P.L., 551 N.W. 77TH STREET, SUITE 111, BOCA RATON, FL, 33487, US

(73) Assignee: MOTOROLA, INC., SCHAUMBURG, IL (US)

(21) Appl. No.: 11/022,558

(22) Filed: Dec. 23, 2004

(51) Int. Cl. G06F 9/445

(52) U.S. Cl. 717/175

(57) ABSTRACT

A wireless communications device (200) includes a software execution environment (230) and a software permissions manager that is associated with the software execution environment (230). The software execution environment (230) defines status items (234) for at least one installed software application package (244, 246, 248 and 250) that is installed in the software execution environment (230). The status items (234) specify prohibited user actions with respect to at least one software application package (244, 246, 248 and 250). The wireless communications device (200) further includes a software package manager (232) that provides communications with the at least one installed software application package (244, 246, 248 and 250). The software package manager (232) performs at least one of ensuring, based upon the status items, a continued presence of installed software application packages, and enforcing the status items for a respective installed software application package.

### CROSS-REFERENCE TO RELATED APPLICATION

The present patent application is related to co-pending and commonly owned U.S. patent application Ser. No. ______, Attorney Docket No. CE13096JSW, entitled “DYNAMIC MANAGEMENT FOR INTERFACE ACCESS PERMISSIONS”, filed on even date with the present patent application, the entire teachings of which being hereby incorporated by reference.

### FIELD OF THE INVENTION

The present invention generally relates to the field of managing software applications in a wireless device and more particularly relates to managing software applications that are to persist in the wireless device.

### BACKGROUND OF THE INVENTION

In addition to their use for voice communications, wireless handsets are incorporating computational abilities that allow their use as processors to execute software applications including software that includes interactive communications with remote data processing systems. Software applications for handsets include downloadable software applications that are installed into the wireless handset for execution. Such software applications are generally directed to small scale deployment and give the user of the wireless handset full control over the application and an ability to delete the application.

Some wireless handset software applications, however, are designed to run all the time. Such software applications can perform various tasks including tracking personnel or equipment, providing continuous data of various types to a remote server. Software applications for wireless handsets can also just run locally on the wireless handset and take measurements to be saved in the wireless handset that will be later offloaded. These software applications currently require an end user knowledgeable in the data application environment to be able to run them effectively. A user of such a wireless handset can unknowingly fail to start the software application or exit the software application by various means, even unintentionally. This is a particular problem with software applications designed to be deployed to many wireless handsets used by enterprise personnel. The user control of these software applications, and an ability to stop or remove them, is often a problem when maintaining a group of wireless handsets in a business enterprise system.

Therefore a need exists to overcome the problems with the prior art as discussed above.

### SUMMARY OF THE INVENTION

Briefly, in accordance with the present invention, a wireless communications device includes a software execution environment and a software permissions manager that is associated with the software execution environment. The software execution environment defines status items for at least one installed software application package that is installed in the software execution environment. The status items specify prohibited user actions with respect to at least one software application package. The wireless communications device further includes a software package manager that provides communications with the at least one installed software application package. The software package manager performs at least the function of ensuring, based upon the status items, a continued presence of installed software application packages, and enforcing the status items for a respective installed software application package.

Further in accordance with the present invention, method for managing application software on a wireless device includes managing application software execution in a software execution environment and defining status items within the software execution environment for at least one installed software application package that is installed in the software execution environment. The status items specify prohibited user actions with respect to at least one software application package. The method also includes ensuring, based upon the status items, continued presence of installed software application packages and enforcing the status items for a respective installed software application package.

### BRIEF DESCRIPTION OF THE DRAWINGS

The accompanying figures where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates an enterprise wireless communications system incorporating exemplary embodiments of the present invention.

FIG. 2 illustrates a circuit block diagram for a wireless handset according to an exemplary embodiment of the present invention.

FIG. 3 illustrates an administration configuration for an exemplary cellular phone shown in FIG. 2, in accordance with an exemplary embodiment of the present invention.

FIG. 4 illustrates a software execution environment in accordance with an exemplary embodiment of the present invention

FIG. 5 illustrates an administration session processing flow as is performed by an exemplary embodiment of the present invention.

FIG. 6 illustrates a software application user interface processing flow as is performed by an exemplary embodiment of the present invention.

FIG. 7 illustrates a permanent application removal processing flow in accordance with the exemplary embodiment of the present invention.

FIG. 8 illustrates a software components diagram in accordance with an exemplary embodiment of the present invention.

### DETAILED DESCRIPTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically.

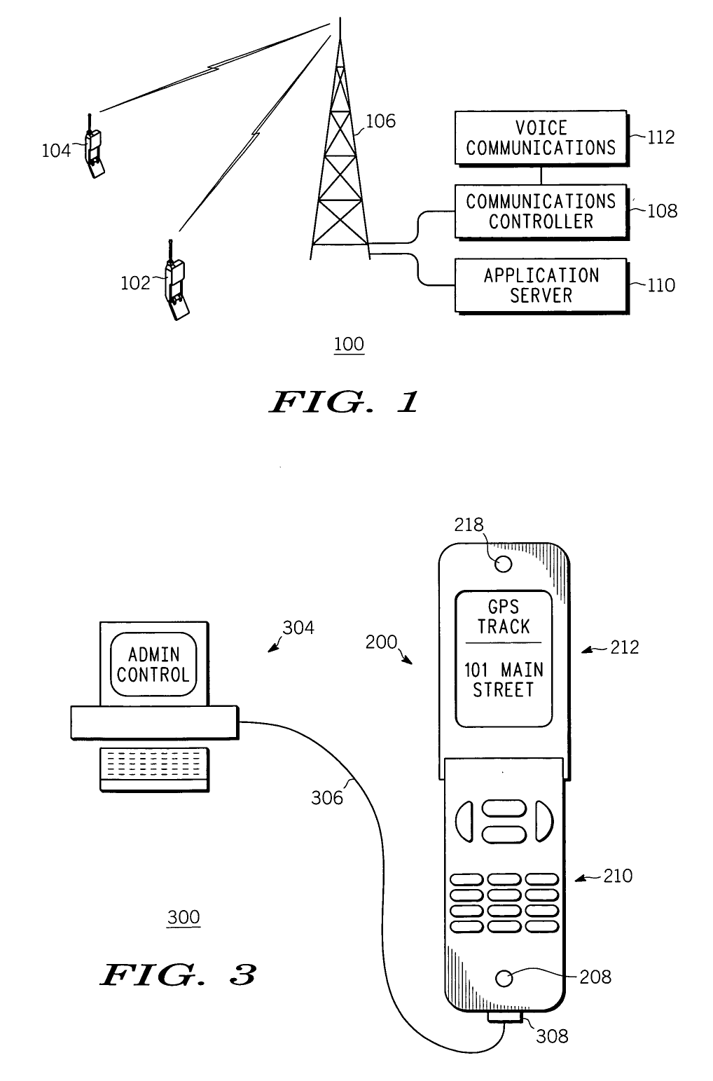

FIG. 1 illustrates an enterprise wireless communications system 100 incorporating exemplary embodiments of the present invention. The exemplary enterprise wireless communications system 100 illustrates two user handsets, a first user handset 102 and a second user handset 104. Two user handsets are illustrated to facilitate understanding and simplify the explanation of the exemplary embodiment of the present invention. The exemplary embodiment of the present invention is able to operate with any number of wireless handsets, including one handset up to any practical number.

The user handsets communicate with a central radio communications system 106, which is shown as a single radio tower for simplicity of explanation. The exemplary embodiment of the present invention is able to operate with a radio system using a single tower or with a distributed radio communications system, such as a cellular phone system, etc. The radio communications system 106 is connected to a communications controller that coordinates operation of the central radio communications system 106 and provides an interconnection to voice communications facilities 112. The voice communications facilities 112

The exemplary enterprise wireless communications system 100 includes an application server 110 that communicates with wireless handsets via the radio communications system 106. The application server 110 of the exemplary embodiment stores and transmits software application packages to wireless handsets, such as the first wireless handset 102. These software application packages are coded in the Java® programming language in the exemplary embodiment. The wireless handsets in the exemplary embodiment have a Java runtime environment that supports installation and execution of downloaded software application packages. The application server 110 of the exemplary embodiment also accepts data transmitted from wireless handsets for storage and/or further processing. In the operation of the exemplary embodiment of the present invention, the wireless handsets execute software applications to collect and/or process data within the wireless handset and then the processed data is transmitted back to the application server for further processing. The application server 110 of various embodiments of the present invention includes data base servers, data reduction processing components, and processing for any other data handling desired. The application server 110 is further able to communicate data to remote terminals and/or other computers as needed or desired for a particular application.

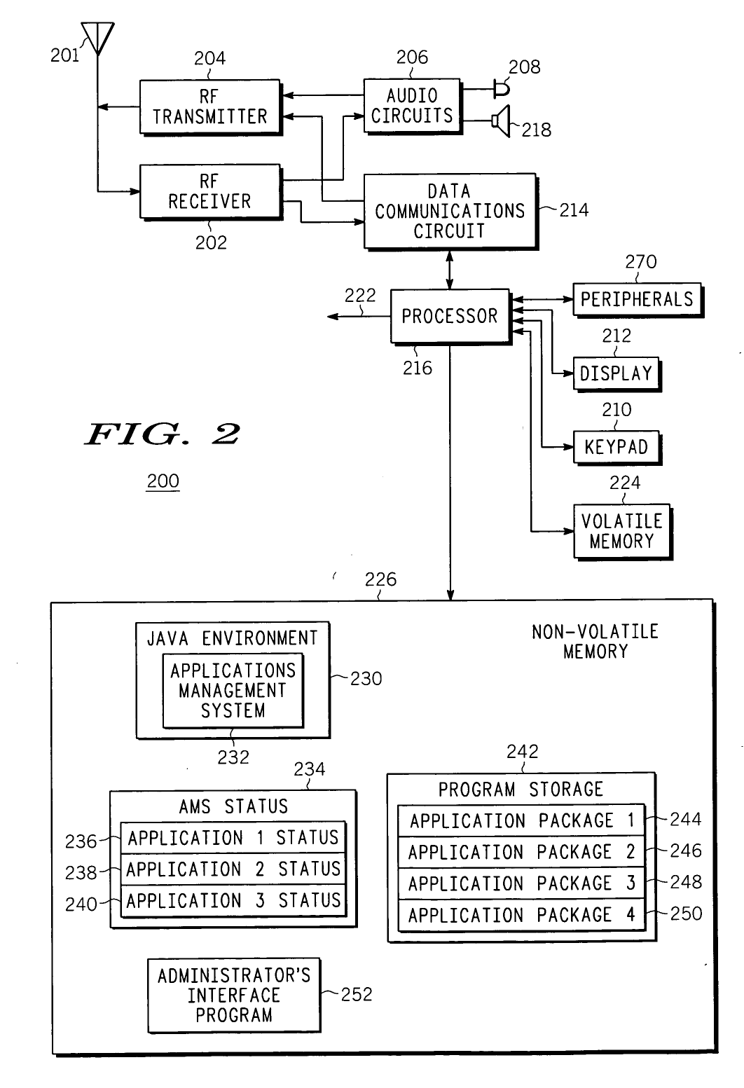

FIG. 2 illustrates a circuit block diagram for a wireless handset 200 according to an exemplary embodiment of the present invention. The exemplary wireless handset 200 includes the antenna 201 connected to an RF receiver 202 and an RF transmitter 204. The exemplary wireless handset 200 is able to simultaneously transmit and receive voice and/or data signals. The RF Transmitter 204 and RF receiver 202 of the exemplary embodiment include dedicated and/or reprogrammable and/or reconfigurable circuits, including programmable processors, to support transmission over multiple wireless communications modes, such as various cellular telephone protocols, and/or wireless data communications protocols.

The RF receiver 202 and the RF transmitter 204 of the exemplary embodiment each connect to audio circuits 206 to provide and accept audio signals to support simplex and/or duplex voice communications over a wireless link. The audio circuits 206 further accept audio signals from the microphone 208 and provide suitably amplified audio signals to speaker 218 to support an audio interface with the user of the exemplary wireless handset 200. Further embodiments of the present invention do not incorporate voice communications capability into the wireless handset but rather only communicate data over a wireless link.

The controller 216 controls the operation of the wireless handset in the exemplary embodiment. Controller 216 is connected to the various components of the wireless handset via control bus 222. Controller 216 communicates data to external devices, such as a base station 106 and/or application server 110, through a wireless link. Controller 216 provides data to and accepts data from data communications circuits 214. Data communications circuits 214 of the exemplary embodiment perform communications processing necessary to implement over-the-air data communications to and from external devices. For example, data processor 214 formats data messages and performs the processing to prepare and transmit or to receive data messages and/or data packets. Data communications circuits 214 also provides data for transmission to the RF transmitter 204 and accepts received data from RF receiver 202.

Controller 216 provides visual display data to the user through display 212. Display 212 of the exemplary embodiment is a Liquid Crystal Display that is able to display alphanumeric and graphical data. Controller 216 also accepts user input from keypad 210. Keypad 210 is similar to a conventional wireless handset keypad and has buttons to accept user input in order to support operation of the exemplary embodiment of the present invention. Further embodiments of the present invention incorporate full alpha-numeric keyboards and/or keyboards adapted to specific purposes for which the wireless handset is intended.

The exemplary wireless handset 200 includes peripherals 270. Peripherals 270 include, for example, one or more of data acquisition equipment, dedicated data processing equipment, and the like. The peripherals 270 of the exemplary embodiment include a GPS receiver. The GPS receiver determines the geographic location of the exemplary wireless handset 200 and provides that geographic location to application software executing on the wireless handset 200. Geographic location data determined by the GPS receiver of the peripherals 270 of the exemplary embodiment is used to track the location of the wireless handset 200 to facilitate, for example, personnel dispatch operations. The peripherals 270 of further embodiments of the exemplary embodiment include, for example, bar code readers, handwriting recognition tablets, RF Identification (RFID) tag readers, and the like to acquire information for application software to process and, if required, communicate to the application server 110. Peripherals 270 further include an external communications port to allow communications with, for example, an external service computer (not shown).

The exemplary wireless handset 200 further includes non-volatile memory 226. Non-volatile memory 226 stores program data and more persistent data for use by the controller 216. Data stored in non-volatile memory 226 of the exemplary embodiment can be changed under control of controller 216 if called for by particular processing performed by the controller 216.

The Non-Volatile memory 226 includes a Java Environment software element 230 that allows processor 216 to provide a Java Runtime Environment on the exemplary wireless handset 200. The Java Environment 230 includes an applications management system 232 allows installation of software application packages and management of installed software application packages on the exemplary wireless handset 200.

The non-volatile memory 226 further includes an administrator's interface program 252. The administrator's interface program 252 is an administrator's access control module that restricts access to administrator functions to authorized users and allows a restricted group of operators to perform privileged operations on the wireless handset 200. Access to the administrator's interface program 252 is controlled in the exemplary embodiment by having an administrative user enter a special password or perform another specific login sequence. Once an administrative user is logged into the administrator's interface program 252, the administrative user is able to install, uninstall and is permitted to change status items, such as permissions and other control data, for the various software application packages that are installed in the program storage 242, discussed below.

The non-volatile memory 226 further includes a program storage 242. Program storage 242 stores application packages, such as application package 1 244, application package 2 246, application package 3 248, and application package 4 250. These application packages are received, for example, over a wireless link via the RF receiver 202, or are installed via an external communications port.

The non-volatile memory 226 further includes an application management system (AMS) status area 234. The AMS status area 234 stores status items for the various installed software application packages 242. Status stored in the AMS status area 234 include, but are not limited to: ensuring that a software application package continues to operate, even if stopped; preventing a software application package from being removed; prohibiting user shutdown of the software application package; prohibiting a user from upgrading a software application package; and causing a user to not be prompted to select an action to be performed by the software application package. The operation of the applications management system 232 enforces these status items for the installed software application package to which they respectively pertain. An application 1 status 236 defines status items for software application package 1 244, an application 2 status 238 defines status items for software application package 2 246, and an application 3 status 238 defines status items for software application package 3 248. The software application package 4 250 does not have an application status field in the AMS status 234 because an administrative user has not defined status items for that software application package.

The exemplary wireless handset 200 further contains volatile memory 224. Volatile memory 224 is able to store transient data for use by processing and/or calculations performed by the controller 216.

FIG. 3 illustrates an administration configuration 300 for an exemplary cellular phone 200 in accordance with an exemplary embodiment of the present invention. The exemplary administration configuration 300 illustrates an exemplary wireless handset 200 connected to an administration control computer 304 via a serial connection 306 through an external connector 308. The administration control computer 304 is also able to communicate with the exemplary wireless handset 200 over a wireless link.

The administration control computer 304 executes an administration control program that allows an administrative operator to, for example, install software application packages and set status items for installed software application packages. The administrative control program of the exemplary embodiment provides a list of software application packages that are installed on the wireless handset 200 and provides menu options to the administrative operator to set status items within the AMS status memory 234 for each installed software application package. The status items that can be set for a particular software application package in the exemplary embodiment are defined by the common list of status items defined by the applications management system 232 that is associated with and is within the Java execution environment 230, and also include any further status items defined by the particular software application package.

Two examples of status items defined for a particular software application package are permanent applications and high reliability application. Permanent applications are applications that cannot be readily removed from the device. If an application designated as a permanent application it is temporarily removed, that application is reinstalled as quickly as possible after the removal event. High reliability applications are applications that are launched when the device is powered up and is not designed to be exited by the user. High reliability applications are able to run in the background and not be visible to the user, or such applications can execute in the foreground as well. The application management system 232 of the exemplary embodiment is a software applications manager and a software package manager that operates to allow the user of the wireless handset 200 less control of designated applications so that these applications can run without fear of accidental deletion or exiting. Such operation is beneficial to enterprise operations that maintain a large number of wireless handsets with specialized software applications that are used by various employees. The restricted ability to modify or remove software application packages provided by the application management system 232 ensures that all wireless handsets maintained by an enterprise have software application packages that are properly configured and have not been altered by the user of the device.

FIG. 4 illustrates a software execution environment 400 in accordance with an exemplary embodiment of the present invention. The exemplary software execution environment includes a set of applications 404, which are stored in program storage 242 of the exemplary embodiment. The applications within the set of applications 404 are controlled by the application management system 232. The application management system 232 of the exemplary embodiment, in turn, provides access to the user interface 402 and other peripherals 270. The user interface 402 of this exemplary embodiment includes a display 212 and keyboard 210. Further embodiments include other types of user interface devices according to the design and requirements of the particular applications to which they are suited.

The applications within the set of applications 404 display information to the user and obtain information from the user through the application management system 232 in the exemplary embodiment. This allows the application management system 232 to control, for example, prompts and queries provided to the user. This allows the application management system 232 to prevent the display of selected prompts to a user or to restrict selections that the user may make in response to prompts or queries to the user. The application management system 232 further provides an interface to the applications within the set of applications 404 to allow those applications to determine the settings of status items within the AMS status memory 234. Applications are able to incorporate selective functionalities based upon the settings of particular status items within the AMS status memory 234 as determined through this interface with the application management system 232.

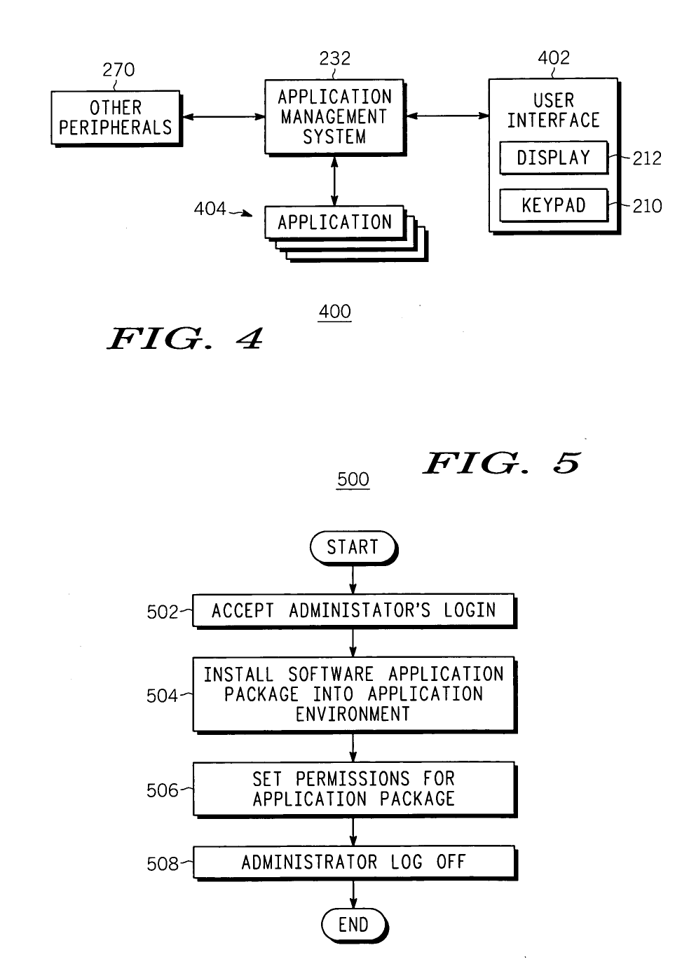

FIG. 5 illustrates an administration session processing flow 500 as is performed by an exemplary embodiment of the present invention. The administration session processing flow 500 is performed by the wireless handset 200 of the exemplary embodiment. Further embodiments are able to distribute the processing of the administration session processing flow 500 between or among various processors as is desired for various applications. The administration session processing flow 500 begins by accepting, at step 502, an administrator's login. Administrators are identified in the exemplary embodiment by a username and password combination that is only provided to administrative users and not to the normal user of a particular wireless handset 200. The administrator's login is able to be performed through a wireless data link to the wireless handset 200 or over a wired connection. The administrative user is also able to login and perform administrative functions by using the user interface functions of the wireless handset 200 without a data communications path to the wireless handset from a separate terminal.

The exemplary administration session processing flow 500 continues by installing, at step 504, a software application package into the application environment of the wireless handset. The application environment of the exemplary embodiment is the java environment 230 described above. The exemplary embodiment of the present invention allows configuration of the application environment, through an administration session, to allow or prevent installation of software application packages by the software application packages to be installed by the user of the wireless handset 200 without requiring an administrator's login.

After a software application package is installed, the processing proceeds by setting, at step 506, status items for any installed application package. The status items are set by the administrator for one or more installed software application packages. The processing then allows the administrator to logoff, at step 508.

The above description of the exemplary administration session processing flow 500 describes installation of a software application package and then setting of status items for installed software application packages. The operation of the exemplary embodiment allows either one or both of these functions to be performed after an administrative login. Multiple iterations of either or both of installing software application packages and setting status items for installed software application packages are able to be performed during a single administration session.

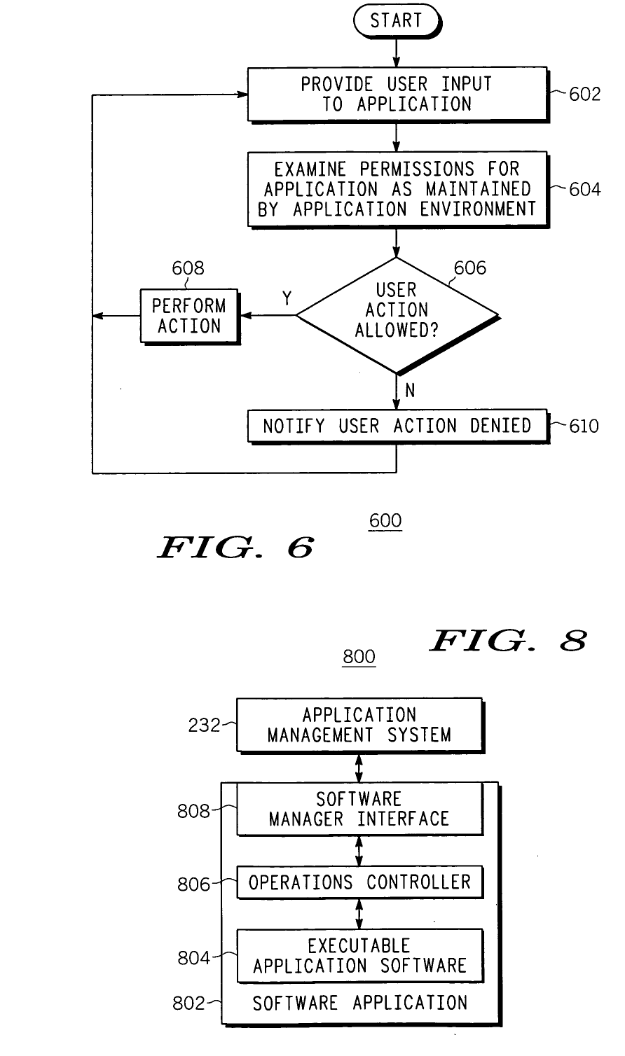

FIG. 6 illustrates a software application user interface processing flow 600 as is performed by an exemplary embodiment of the present invention. The exemplary software application user interface processing flow 600 begins by providing, at step 602, user input to an application that is associated with a software application package. This user input is able to include requesting an operation such as removing the application, reconfiguring the application, or any other operation. The processing next examines, at step 604, the status items, as stored in the AMS status 234 and maintained by the application environment, for that application to determine if the requested user action is allowed. The exemplary embodiment of the present invention stores, in the AMS status 234, status items that define if the user is able, for example, to stop or to remove the application, to override specified software application package functions or to be prompted to select an action. The AMS status 234 of the exemplary embodiment further stores status items for software application packages that indicate that the application is a “high reliability application” that automatically starts upon powering up of the wireless handset 200. The operation of the exemplary embodiment further continues to monitor the continued execution of high reliability applications and restarts those applications if one is stopped for some reason. In the exemplary embodiment, the software execution environment periodically checks a list of application requesting automatic restarting, which includes the high reliability applications, against a table of currently executing applications. If any high reliability applications are determined to not be running, the software execution environment starts any of those applications that were observed to not be running. This check is able to be performed based upon a periodic timer or it can be performed automatically at sensible points in the application lifecycle, such as when the software execution environment exits due to no currently executing applications or when starting a new application.

In the exemplary embodiment, the application management system 232 keeps track of which applications are stopped and which are running in either the background or foreground. The application management system 232 further keeps track of which apps are indicated to be “high-reliability” applications and manages various activities that control ending execution of high-reliability applications. When performing activities that end applications, such as installing new applications, de-installing applications, re-initializing the Java System, etc., the application management system 232 operates to restart the high-reliability applications. The application management system 232 also immediately restarts high-reliability applications if such applications end on its own. Applications end without direction from the application management system 232 due to, for example, an error or simply due to the way the application is written. An application can also end itself via a standard Java function call.

The processing next determines, at step 606, if the requested action is allowed. If the requested action is allowed, as defined by the status items stored in the AMS status 234 for this software application package, the processing performs, at step 608, the requested action. If, however, the requested action is not allowed, the processing notifies, at step 610, the user that the requested action is denied. The processing then continues operation of the application by returning to providing, at step 602, user input to the application.

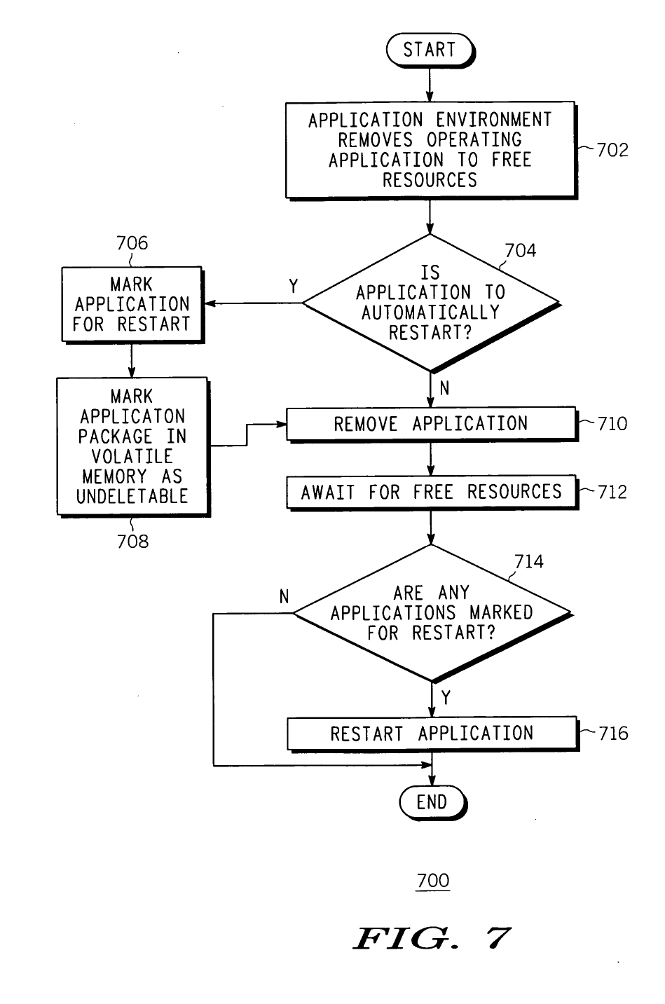

FIG. 7 illustrates a permanent application removal processing flow 700 in accordance with the exemplary embodiment of the present invention. The exemplary permanent application removal processing flow 700 is performed by the exemplary embodiment when, for example, the operation of the wireless handset 200 temporally requires the resources consumed by the application being removed or when the non-volatile memory 226 is reformatted. In conventional systems, application are removed and are not re-installed until a specific request for the application is made, such as by the user. The operation of the exemplary embodiment of the present invention allows applications to be identified as “permanent” in the status items stored in the AMS status 234, which causes those applications to be preserved in the program storage 242 and to be automatically re-installed as soon as possible after their removal. Applications in the exemplary embodiment are able to be independently identified as either one or both of a “permanent” application that is not to be removed and as a “high reliability application” that is to be automatically restarted.

The exemplary permanent application removal processing flow 700 begins by the application environment removing, at step 702, an operating application to free resources. The processing next determines, at step 704, if the application being removed it to automatically restart. In the exemplary embodiment, applications that are to automatically restart are identified as permanent in the AMS status 234 for that application package.

If the application is to automatically restart, the processing marks, at step 706, the application for restart. The processing then marks, at step 708, the application package in non-volatile memory 226 as undeletable. This causes the software application package to remain available for re-installation when resources are available.

After marking the application package undeletable or if the application being removed is not to automatically restart, the processing removes, at step 710, the application. The processing of the exemplary embodiment then awaits, at step 712, for free resources in which to re-install removed software application packages that are to be automatically restarted. Once free resources are available, the processing determines, at step 714, if any applications are marked for restart. If there are applications so marked, those applications are restarted, at step 716. The exemplary permanent application removal processing flow 700 then terminates.

FIG. 8 illustrates a software components diagram 800 in accordance with an exemplary embodiment of the present invention. The software components diagram 800 includes a software application 802 that has an interface, through the software manager interface 808, with the application management system 232, described above. The software application 802 includes an executable application software component 804 that performs the functions for the software application.

The software application 802 further includes an operations controller 806 that that communicates with the software manager interface 808 and the executable application software. The operations controller operates to determine if status items, such as permissions, as maintained by the application management system 232 prohibit an operation that the executable application software 804 is about to perform. The operations controller 806 of the exemplary embodiment operates to preclude, based upon the status items, the executable application software 804 from performing the prohibited action.

The present invention can be realized in hardware, software, or a combination of hardware and software. A system according to an exemplary embodiment of the present invention can be realized in a centralized fashion in one computer system, or in a distributed fashion where different elements are spread across several interconnected computer systems. Any kind of computer system—or other apparatus adapted for carrying out the methods described herein—is suited. A typical combination of hardware and software could be a general purpose computer system with a computer program that, when being loaded and executed, controls the computer system such that it carries out the methods described herein.

The present invention can also be embedded in a computer program product, which comprises all the features enabling the implementation of the methods described herein, and which—when loaded in a computer system—is able to carry out these methods. Computer program means or computer program in the present context mean any expression, in any language, code or notation, of a set of instructions intended to cause a system having an information processing capability to perform a particular function either directly or after either or both of the following a) conversion to another language, code or, notation; and b) reproduction in a different material form.

Each computer system may include, inter alia, one or more computers and at least one computer readable medium that allows a the computer to read data, instructions, messages or message packets, and other computer readable information. The computer readable medium may include non-volatile memory, such as ROM, Flash memory, Disk drive memory, CD-ROM, and other permanent storage. Additionally, a computer medium may include, for example, volatile storage such as RAM, buffers, cache memory, and network circuits. Furthermore, the computer readable medium may comprise computer readable information in a transitory state medium such as a network link and/or a network interface, including a wired network or a wireless network that allow a computer to read such computer readable information.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

What is claimed is:

1. A wireless communications device comprising:
a software execution environment;
a software permissions manager, associated with the software execution environment, that defines status items for at least one installed software application package that is installed in the software execution environment, the status items specifying prohibited user actions with respect to at least one software application package; and
a software package manager that provides communications with the at least one installed software application package, the software package manager operating to at least one of ensuring, based upon the status items, continued presence of installed software application packages, and enforcing the status items for a respective installed software application package.

2. The wireless communications device of claim 1, wherein the status items comprise at least one of prohibiting removal, prohibiting software application package shutdown, prohibiting user override of specified software application package functions and ensure software application package restart.

3. The wireless communications device of claim 1, wherein the software application package manager detects a stopped installed software application package and, in response to detecting a stopped installed software application package, restarts the stopped installed software application package.

4. The wireless communications device of claim 1, wherein the software package manager prevents, based upon the status items, an operating software application package from stopping.

5. The wireless communications device of claim 1, wherein the software package manager prevents, based upon the status items, an operating software application package from prompting a user select an action.

6. The wireless communications device of claim 1, wherein the software package manager prevents, based upon the status items, removal of installed software application packages.

7. The wireless communications device of claim 1, further comprising an administrator's access control module that restricts access to administrator functions to authorized users, and wherein the software status items manager only permits status item changes through the administrator's access control module.

8. A software application, comprising:
executable application software;
a software manager interface for receiving status items from a software package manager; and
an operations controller for precluding, based upon the status items, at least one selected operation of the executable application software.

9. The software application of claim 8, wherein the at least one selected operation comprises a user prompt to avoid execution of a portion of the executable application software.

10. The software application of claim 8, wherein the at least one selected operation comprises a user prompt to stop execution of the executable application software.

11. The software application of claim 8, wherein the at least one selected operation comprises a user prompt to upgrade the executable application software.

12. A method for managing application software on a wireless device, the method comprising the steps of:
managing application software execution in a software execution environment;
defining status items within the software execution environment for at least one installed software application package that is installed in the software execution environment, the status items specifying prohibited user actions with respect to at least one software application package; and
ensuring, based upon the status items, continued presence of installed software application packages; and
enforcing the status items for a respective installed software application package.

13. The method of claim 12, wherein the status items comprise at least one of prohibiting removal, prohibiting software application package shutdown, prohibiting user override of specified software application package functions and ensure software application package restart.

14. The method of claim 12, wherein the ensuring comprises detecting a stopped installed software application package; and
restarting, in response to detecting a stopped installed software application package, the stopped installed software application package.

15. The method of claim 12, wherein the ensuring comprises preventing, based upon the status items, an operating software application package from stopping.

16. The method of claim 12, wherein the software application package manager communicating operates to prevent, based upon the status items, an operating software application package from prompting a user select an action.

17. The method of claim 12, wherein the communicating operates to prevent, based upon the status items, removal of installed software application packages.

18. The method of claim 12, further comprising restricting access to an administrator's access control module, and wherein the defining status items is only performed through the administrator's access control module.
